(19) United States
(12) Patent Application Publication
(10) Pub. No.: US 2017/0169166 A1
(43) Pub. Date: Jun. 15, 2017

(54) COLLABORATIVE CHARTING SYSTEM WITH DEVICE INTEGRATION

(71) Applicant: Practice Fusion, Inc., San Francisco, CA (US)

(72) Inventors: Sandra M. COLLEY, Dublin, CA (US); Thomas W. Evans, Concord, CA (US); Karen Luk, San Francisco, CA (US)

(21) Appl. No.: 14/964,285

(22) Filed: Dec. 9, 2015

(51) Int. Cl. G06F 19/00; G06F 3/0484; G06F 3/0482; H04L 29/06

(52) U.S. Cl. CPC G06F 19/322; G06F 19/3487; H04L 65/4015; G06F 3/04847; G06F 3/0482

(57) ABSTRACT

Embodiments enable collaborative charting with device integration. A charting database includes a chart partitioned into a plurality of fields describing a patient's medical information. The charting database also includes for each field, authorization information describing who is permitted to alter the field. A charting interlace receives, from at least two devices, changes concurrently made to at least one of the plurality of fields. A concurrent charting component tracks the plurality of devices to determine which are accessing or altering the at least one changed field. The concurrent charting component determines based on the authorization information, which of the received concurrent changes are authorized. Upon resolving the concurrent changes from at least two devices, a propagation component sends the resolved concurrent change to devises, from the tracked plurality of devices, determined to be accessing or altering the changed field.

### FIELD

This disclosure is generally related to collaborative chatting systems, and more particularly to systems tor integrating device interactions with concurrent charting.

### BACKGROUND

Medical records related to a patient's health information are essential to the practice of medical care. Traditionally, medical records were paper-based documents. The emergence of electronic health record (EHR) systems offers medical professionals and patients with new functionalities that paper-based medical records cannot provide. An EHR, sometimes known as electronic medical record (BMR), is a collection of electronically stored information about an individual patient's lifetime health, status and health care, EHRs may include a broad range of data, including demographics, medical history, medication and allergies, immunization status, laboratory test results, radiology images, vital signs, personal statistics like age and weight, and billing information. Many commercial EHR systems combine data from, a number of health, care services and providers, such as clinical care facilities, laboratories, radiology providers, and pharmacies.

EHRs are a drastic improvement over paper-based medical records. Paper-based medical records require a large amount of storage space. Paper records are often stored in different locations, and different medical professionals may each stave different and incomplete records about the same patient. Obtaining paper records from multiple locations for review by a health care provider can be time consuming and complicated. In contrast EHR data is stored in digital format, and thus can be accessed from anywhere. EHR systems significantly simplify the reviewing process for health care providers. Because data in EHRs can be linked together, EHRs vastly improve the accessibility of health records and the coordination of medical care.

EHRs also decrease the risk of health care professionals misreading records. Poor legibility is often associated with handwritten, paper medical records, which can lead to medical errors. EHRs, on the other hand, are inherently legible given that they are typically stored in typeface. In addition, electronic medical records enhance the standardization of forms, terminology and abbreviations, and data input, which help ensure reliability of medical records. Further, EHRs can be transferred electronically, thus reducing delays and errors in recording prescriptions or communicating laboratory test results.

The benefits of digitizing health records are substantial. Health cave providers with EHR systems have reported better outcomes, fewer complications, lower costs, and fewer malpractice claim payments. But despite EHRs' potential in drastically improving the quality of medical care, only a low percentage of health care providers use EHR systems. While the advantages of EHRs are significant, they also carry concerns, including security and risks, high costs, lost productivity during EHR implementation or computer downtime, and lack of EHR usability.

The Health Insurance Portability and Accountability Act (HIPAA), enacted in the U.S. in 1996, establishes rules for access, authentication, storage, auditing, and transmittal of medical records. HIPPA sets a limit as to what health information can be disclosed to third parties, and who can view a patient's medical records. HIPPA protects information in electronic medical records, such as information doctors and nurses input, recorded conversations between a doctor and a patient, and billing in formation. The HIPAA Security Rule, effective on Apr. 20, 2005 for most coveted entities, adds additional constraints to electronic data security and the storage and transmission of private health information (PHI). Despite the regulatory restrictions, privacy and security threats are still a major risk of the current EHR systems. The convenient and fast access to patients' health records through an EHR system introduces a host of security concerns. Medical information in digital format is vulnerable to various privacy exploitations associated with hacking, computer theft, malicious attack, or accidental disclosure, According to some estimates, between 250,000 and 500,000 patients experience medical identity theft every year.

Additionally, the high cost of EHRs also significantly hinders EHR adoption. A large number of physicians without EHRs have referred to initial capital costs ax a barrier to adopting EHR systems. Cost concerns are even more severe in smaller health care settings, because current EHR systems are more likely to provide cost savings for large integrated institutions than for small physician offices. During EHR technology's implementation, productivity loss can further offset efficiency gains. The need to increase the size of information technology staff to maintain the system adds even more costs to EHR usages.

Usability is another major factor that holds back adoption of EHRs. It is particularly challenging to develop user-friendly EHR systems. There is a wide range of data that needs to be integrated and connected. Complex information and analysis needs vary from setting to setting, among health care provider groups, and from function to function within a health care provider group. To some providers, using electronic medical records can be tedious and time consuming, and the complexity of some EHR systems renders the EHR usage less helpful. Some doctors and nurses also complain about the difficulty and the length of time to enter patients' health information into the system.

Under-utilization of EHR systems, despite incentives and mandates from the government and the tremendous potential of EHRs in revolutionizing the health care system, calls for better EHR systems that are secure, cost-effective, efficient, and user-friendly.

Comprehensive EHR systems can provide capabilities far beyond simply storing patients' medical records. Because EHR systems offer health care providers and their workforce members the ability to securely store and utilize structured health information, EHR systems can have a profound impact on the quality of the health care system. In framework for Strategic Action on Health Information Technology, published on Jul. 21, 2004, the Department of Health & Human Services (HHS) outlined many purposes for EHR services. The outlined purposes include, among other things, improving health care outcomes and reducing costs, reducing recordkeeping and duplication burdens, improving resource utilization, care coordination, active quality and health status monitoring, reducing treatment variability, and promoting patients' engagement in and ownership over their own health care.

### Collaborative Charting

A medical chart may be one or more formatted documents that refer to a patient's data from the EHR system. For example, a medical chart, may be populated or updated during a patient encounter. To review a patient's medical history and to document treatments and diagnoses during a patient encounter, a medical personnel may need to open the patient's medical chart within a charting application.

When, a patient visits a clinic for a doctor's appointment, one or more medical personnel, each operating one or more devices, may collaborate with each other. Furthermore, the patient's doctor may need to collaborate with medical personnel across medical practices.

When multiple medical personnel collaborate to treat a patient, the multiple medical personnel may each need to access the patient's medical chart. But, while conventional systems may allow multiple medical personnel to view the data within the medical chart, they may only permit one medical personnel at a time to edit the chart. Other medical personnel may need to wait for write permissions or request the medical personnel having write permissions to close or quit the medical chart. Also, while a medical personnel has the medical chart opened within the charting application, changes made to the medical chart by another medical personnel having write or edit privileges may not necessarily be visible to the medical personnel. Thus, current charting interfaces technologically impedes users from concurrently and collaboratively accessing and editing content within the medical chart.

In addition, medical personnel may often record patient information such as measured vitals statuses and a patient's brief statement of complaint on paper documents before transcribing them into the medical chart. To improve information flow during a patient encounter, the medical chart may be interfaced with one or more information-gathering devices that electronically transmit information, such as vitals statuses, gathered from patients. Similar to the problems noted above, a medical personnel accessing a medical chart in real-time may not be able to view the latest information obtained by the information-gathering gathering devices. The medical personnel may need to, for example, reopen the medical chart to obtain the latest updates, improved systems and methods ate needed to provide interface technologies that enable collaborative charting with device integration.

### BRIEF SUMMARY

Embodiments enable collaborative charting with device integration. A charting database includes a chart partitioned into a plurality of fields describing a patient's medical information. The charting database also includes for each field, authorization information describing who is permitted to alter the field. A charting interface receives, from at least two devices, changes concurrently made to at least one of the plurality of fields. A concurrent charting component tracks the plurality of devices to determine which are accessing or altering the at least one changed field. The concurrent charting component determines based on the authorization information, which of the received concurrent changes ate authorized. Upon resolving the concurrent changes front at least two devices, a propagation, component sends the resolved concurrent change to devices, from the tracked, plurality of devices, determined to be accessing or altering the changed field.

Embodiments include a method, computer-readable storage, and system for enabling collaborative charting among users where charts are interfaced with devices. Further embodiments, features, and advantages, as well as the structure and operation of the various embodiments, are described in detail below with reference to accompanying drawings.

### BRIEF DESCRIPTION OF THE DRAWINGS

The accompanying drawings, which are incorporated herein, and form part, of the specification, illustrate the present disclosure and, together with the description, further serve to explain the principles of the disclosure and to enable one of ordinary skill in the art to make and use the disclosure.

FIG. 1 is a diagram illustrating an example computer system for providing collaborative charting with device integration, according to an example embodiment.

FIG. 2 is a diagram illustrating a charting management system, according to an example embodiment.

FIG. 3 is an example chart illustrating various fields, according to an example embodiment.

FIG. 4 is a diagram illustrating access request information, according to an example embodiment.

FIG. 5 is a diagram illustrating authorization information associated with the chart, according to an example embodiment.

FIG. 6 is a flowchart illustrating an example method for providing collaborative charting with device integration, according to an embodiment.

FIG. 7 is a diagram illustrating, an example computing system, according to an embodiment.

The drawing in which an element first appears is typically indicated by the leftmost digit or digits in the corresponding reference number. In the drawings, like reference numbers may indicate identical or functionally similar elements.

### DETAILED DESCRIPTION

Embodiments relate to enabling collaborative and concurrent charting with device integration. To provide real-time updates to users concurrently accessing a patient's medical chart, a charting server may need to track the users' devices or other devices that access or alter one or more fields of the medical chart. When at least two devices make changes concurrently, the charting server may resolve the concurrent changes by applying the concurrent changes directly or merging the concurrent changes. Then, the charting server may propagate resolved changes to devices, from the tracked devices, determined to be accessing or altering one or more fields affected by the concurrent changes. As will be described below, embodiments may additionally provide flexible and customizable authorization information that enables some or all of the fields within a patient's medical chart to be shared with specific medical personnel within a medical practice or across different practices.

In the detailed description that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

### System

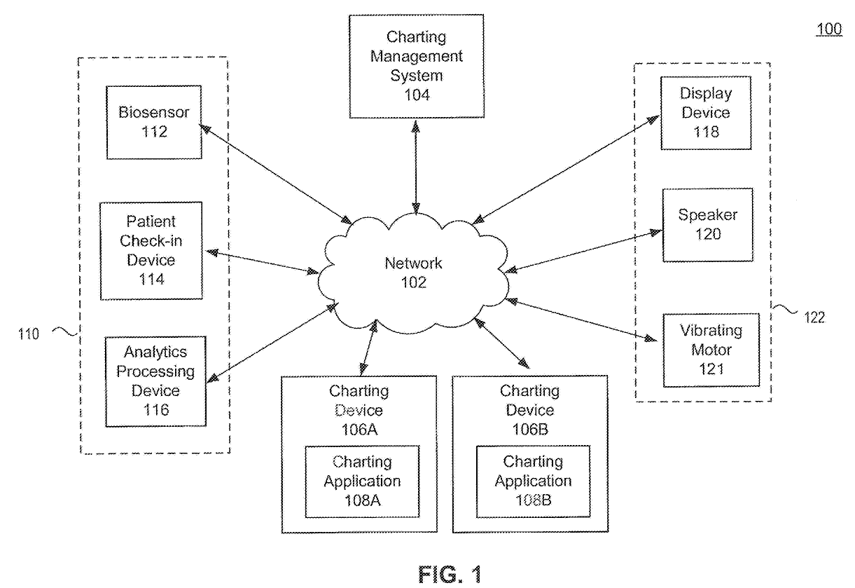

FIG. 1 illustrates a computer system 100 that provides collaborative charting with device integration, according to an example embodiment. Computer system 100 may include network 102, charting management system 104, charting devices 106, information-gathering devices 110, and notification devices 122. Charting management system 104 manages patient information including medical information in medical charts stored within one or more databases. Additionally, charting management system 104 may provide to charting devices 106, operated by respective medical personnel, respective charting applications 108 that enable medical personnel to read from and write to a medical chart accessed by charting application 108. A patient's medical chart may include one or more fields describing medical information of the patient. One or more fields may include patient statuses gathered by information-gathering devices 110. One or more notification devices 122 may further present real-time information from one or more fields of the medical chart managed by charting management system 104.

In an embodiment, charting management system 104 tracks one or more charting devices 106 concurrently accessing (e.g., has opened or requesting) one or more fields of the same medical chart. Each charting device 106 may access the medical chart using respective charting application 108. Charting management system 104 also tracks information-gathering device 110 that are coupled with or are accessing (e.g., sending field updates) specific fields of the medical chart. Therefore, charting management system 104 may receive changes concurrently made from both charting devices 106 and information gathering devices 110.

Charting management system 104 may also track one or more notification devices 122 coupled to or assigned to one or more fields of the medical chart. When charting management system 104 concurrently receives one or more changes to the medical chart from multiple charting devices 106 or information-gathering devices 110, charting management system 104 may determine which changes may be applied concurrently and which devices to send the applied changes. For example, charting management system 104 may propagate applied changes to one or more charting devices 106 and one or more notification devices 122 based on authorization information associated with or assigned to the medical chart or fields of the medical chart.

Network 102 enables charting management system 104 to communicate and interface with each of the following types of devices; charting devices 106, information-gathering devices 110, and notification devices 122. In an embodiment, network 102 may be one or more of the following: local area network (LAN), metropolitan area network (MAN), wide area network (WAN), or any other point-to-point or multipoint-to-multipoint networking protocols. For example, if the devices shown are operating within a close proximity, such as within a single building, network 102 may likely be a secure LAN. Network 102 may be implemented using other wired or wireless communication technologies and protocols complying with various communication standards.

Information-gathering devices 110 may be electronic devices that, monitor or gather patient information to be saved in charting management system 104 or displayed within charting application 108 provided by charting management system 104. In an embodiment, information-gathering devices 110 may be network-enabled devices that include network circuitry for sending gathered or monitored data to charting management system 104 via network 102. Example information-gathering devices 110 may include biosensor 112, patient check-in device 114, or analytics processing device 116.

Biosensor 112 may be a sensor device that produces a biometric signal representing a current status of a patient. For example, during a patient's appointment with his doctor, a medical personnel (e.g., a nurse or a the doctor) may apply biosensor 112 or multiple biosensors to the patient to measure or obtain one or more of: an X-ray, a height, a weight, a body mass index, a respiration rate, a heart rate, a blood pressure, a perspiration rate, an oxygen level, a body temperature, a voltaic skin response, a bioelectric activity (e.g., EKG, EEG, neuronal probe data), or a change in any of the above, in an embodiment, biosensor 112 may be a patient-wearable device, including smart watches, accelerometers, and pacemakers. In an embodiment, one or more of the patient's biometric measurements may be gathered periodically to monitor a patient's biometrics over a period of time.

Patient check-in device 114 may be a computing device that receives a patient's input. The computing device may include a hand held device such as a tablet device or a smartphone, or a workstation such as a laptop or desktop computer. In an embodiment, an application implemented on any computing device may provide the functionality of patient cheek-in device 114. For example, during a doctor's appointment, a patient arriving at a clinic may check in using patient check-in device 114 (e.g., a tablet device) to indicate that the patient has arrived at the clinic. Patient check-in device 114 may further request that the patient input past medical history, current medical status or chief medical complaint, or other information indicating a reason for die patient's visit to the clinic.

Analytics processing device 116 may be a computing device that provides a lab result or a processed result, such as a blood test, of a patient's measured biometrics. In an embodiment, analytics processing device 116 may be operated at a separate clinic or laboratory, for example, a patient may be requested by his doctor to take a blood test at a remote clinic containing analytics processing device 116 that processes the patient's blood test.

In conventional systems, due to lack of device integration with charting management systems, a medical personnel may need to record gathered information from information-gathering devices 110 in separate systems and later insert measurements or other gathered information into a medical chart maintained by the charting management systems. Charting management system 104 instead provides an improved charting interface that integrates and interfaces directly with information-gathering devices 110.

Charting device 106 may be a computing device implementing charting application 108, which allows a user operating charting device 106 to access a patient's medical chart managed by charting management system 104. Users that may operate charting device 106 to collaboratively and concurrently access the patient's medical chart may include administrators, the patient himself, the patient's provider, partners of the provider such as third-party lab technicians, and other providers invited by the patient's provider to engage in a collaborative charting session. Exemplary computing devices may include, without limitation, a tablet, a mobile phone, a personal digital assistant (PDA), other handheld devices, a laptop, or a desktop computer, in an embodiment, charting application 108 may instead, be a web-based portal provided by charting management system 104 that charting device 106 may access through a web browser on charting device 106.

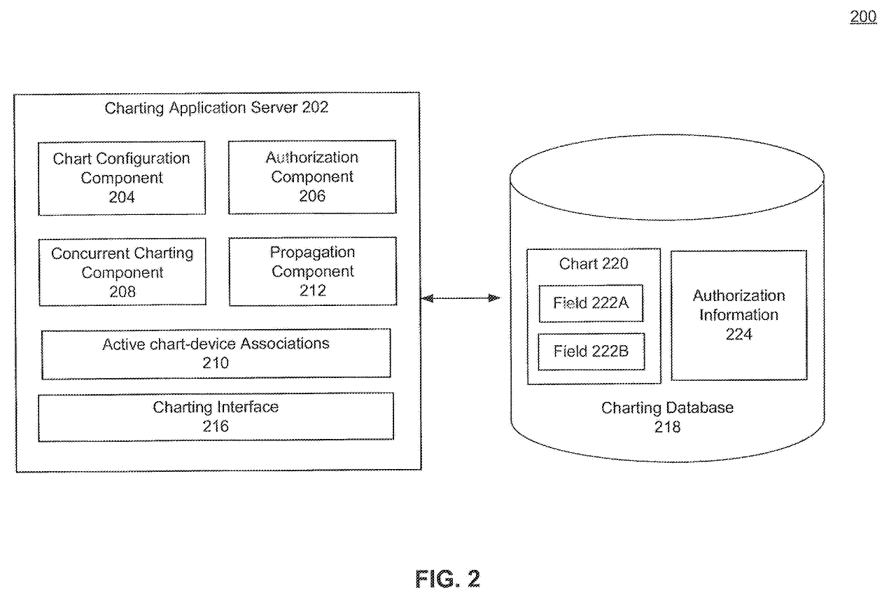

In an example, a medical personnel such as a receptionist operating charting device 106A may use charting application 108A to request access to a patient's medical chart. Depending on authorization information associated with the medical chart or associated with specific fields within the medical chart, charting management system 104 may decide to present the requested medical chart or portions (e.g., one or more fields) of the medical chart to the requesting medical personnel. As father described with respect to FIG. 2, authorization information may be related to specific requesting devices, device types, user privileges of requesting user, specific fields of the medical chart, or an access type of the request.

Charting application 108 may provide to medical personnel a medical record that contains up-to-date patient information without requiring medical personnel to re-open the medical record opened within charting application 108. In an embodiment, the up-to-date medical record may include changes made by other medical personnel concurrently accessing the medical record or changes concurrently gathered by information-gathering devices 110.

Notification devices 122 may be electronic devices that reflect the latest status of one or more fields from medical charts managed by charting, management system 104. Notification devices 122 may be considered passive devices because they do not affect or write to the one or more fields from the medical charts. In an embodiment, notification devices 122 may be triggered to respond whenever notification devices 122 receives the latest one or more fields assigned to respective notification devices 132. As shown, notification devices 122 may include display device 118, speaker 120, or vibrating motor 121 to provide data from the one or more fields through visual feedback, auditory feedback, or a haptic feedback, respectively. In an embodiment, notification devices 122 may be triggered to receive from charting management system 104 or output notifications depending on whether data in the one or more field exceed thresholds associated with the one or more fields. In an embodiment, modification devices 122 may be network-enabled devices that include communication circuitry for receiving data from charting management system 104 via network 102.

In an embodiment, display device 118 may include an LED bulb or display screen near a room that indicates whether the room is being used or has been assigned to a patient. For example, upon receiving data from patient check-in device 114, charting management system 104 may assign the room to an arriving patient by updating a “room” field. Display device 118 may receive the assignment based on the “room” field and turn on the LED bulb or display, for example, the patient's name.

In an embodiment, speaker 120 may be coupled to, for example, a vitals status field of a medical chart. When information-gathering devices 110, such as biosensor 112, send vitals measurements to charting management system 104, chatting management system 104 may determine whether corresponding vitals status fields are updated. If a vitals status field has been updated, charting management system 104 may determine to send the updated vitals status field to any or all coupled notification devices 122, e.g., speaker 120. Speaker 120 may be configured to, for example, transmit audible sounds or alarms when the received vitals status field exceeds a predetermined threshold configured by charting management system 104.

One or more of the devices and systems depicted in computer system 100 may be implemented on one or more computing devices. Such a computing device may include, but is not limited to, a device having a processor and memory, including a non-transitory memory, for executing and storing instructions. The memory may tangibly embody the data and program instructions. Software may include one or more applications and an operating system. Hardware can include, but is not limited to, a processor, memory, and graphical user interface display. The computing device may also have multiple processors and multiple shared or separate memory components. For example, the computing device may be a part of or the entirety of a clustered computing environment.

FIG. 2 is a diagram of a charting management system 200, according to an example embodiment. In an embodiment, charting management system 200 may be an example implementation of charring management system 104 from FIG. 1. Charting management system 200 may include charting application server 202 and charting database 218. Charting database 218 may be any type of structured data store, including a relational database, that stores a patient's medical chart, chart 220, partitioned into fields 222 describing medical information of the patient. Charting database 218 may also store permissions of users or devices in authorization information 224. Permissions may include read or write access, or the right to grant or revoke permissions of other users or devices. Charting application server 202 includes five components; chart configuration component 204, authorization component 206, concurrent charting component 208, propagation component 212, and charting interface 216.

In general, charting application server 202 may provide charting applications 108 that are implemented oil charting devices 106 of FIG. 1. Charting interface 216 presides a view of a medical chart, such as chart 220, presented by for example, chatting application 108A operated by a user including, for example, medical personnel. Charting interface 216 may receive inputs or enable processing of inputs received from charting devices 106 being operated by corresponding authorized users, in an embodiment, charting interface 216 may interface with information-gathering devices 110 to receive gathered or measured patient statuses or information.

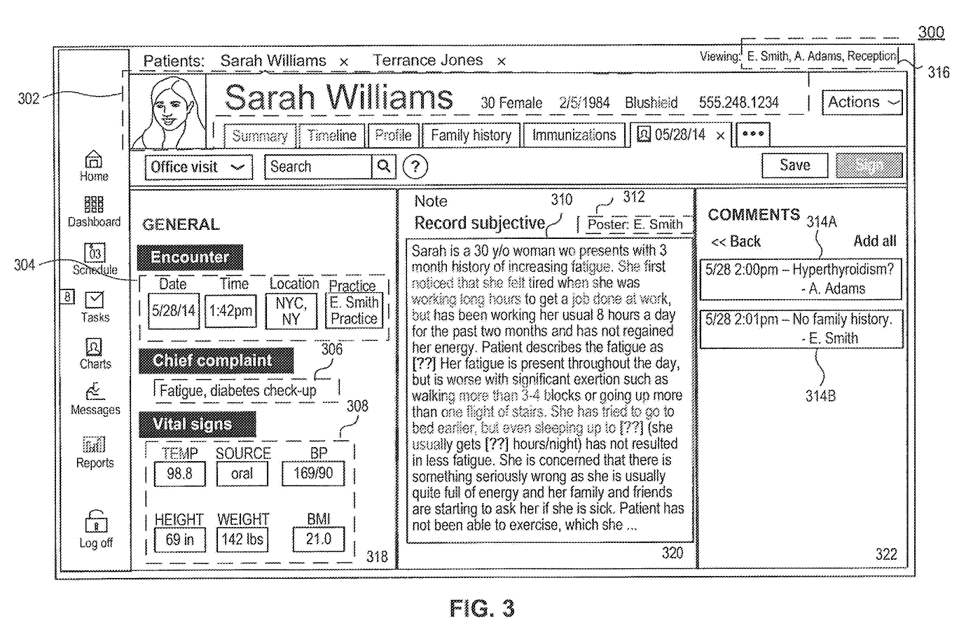

Chart configuration component 204 receives a selection of fields, such as fields 222, to form a chart. In an embodiment, one or more selected fields 222 may be received from an administrator operating, for example, charting application 108A of charting device 106A. An administrator may he a designated user, such as a doctor, authorized by authorization component 206 to edit or specify the types of fields and the number of fields to be displayed in the chart. For example, based on the received one or more selected fields 222, chart configuration component 204 may form the chart, such as an example chart 300 depicted in FIG. 3, that is partitioned into the selected fields. Upon configuration, chart configuration component 204 may save the chart and associated fields as chart 220 and fields 222, respectively.

In an embodiment, chart configuration component 204 may further associate authorization or permission settings with chart 220 or each field 222 of chart 220. These authorization or permission settings are saved in authorization information 224 and describe which devices or users are permitted to access or alter field 222 of chart 220. In an embodiment, multiple entities including, for example, medical personnel the patient, or specific devices from FIG. 1, may be assigned specific permission settings such as read-only, write-only, or read-write for a field from a medical chart or, in an embodiment, for the entire medical chart. Permission settings may be prioritized based on a type of an entity. For example, the patient's settings may have the highest priority, followed by the patient's primary physician's settings, and other medical personnel's settings may have the lowest priority.

In an embodiment, chart configuration component 204 may enable a user, such as a patient's primary doctor, to grant or revoke another user permission to access or alter the patient's medical chart. The grant or revoke settings may be stored in authorization information 224. The access-changing user may also grant/revoke permission to access or alter only specific fields of the medical chart. For example, during a referral or transition-of-care scenario, a patient's primary doctor may refer the patient to a specialist practitioner. Upon request by the patient's primary doctor, chart configuration component 204 may grant, in real time, the specialist practitioner access to the patient's medical chart and one or more fields of the medical chart. For example, the specialist practitioner may receive a link that accesses a web-portal for viewing the patient's medical chart. Therefore, the specialist practitioner from a practice different from the primary doctor may collaborate with the primary doctor in real time. Upon conclusion of the collaborative charting session with the specialist practitioner, the primary doctor may, for example, revoke the specialist practitioner's access.

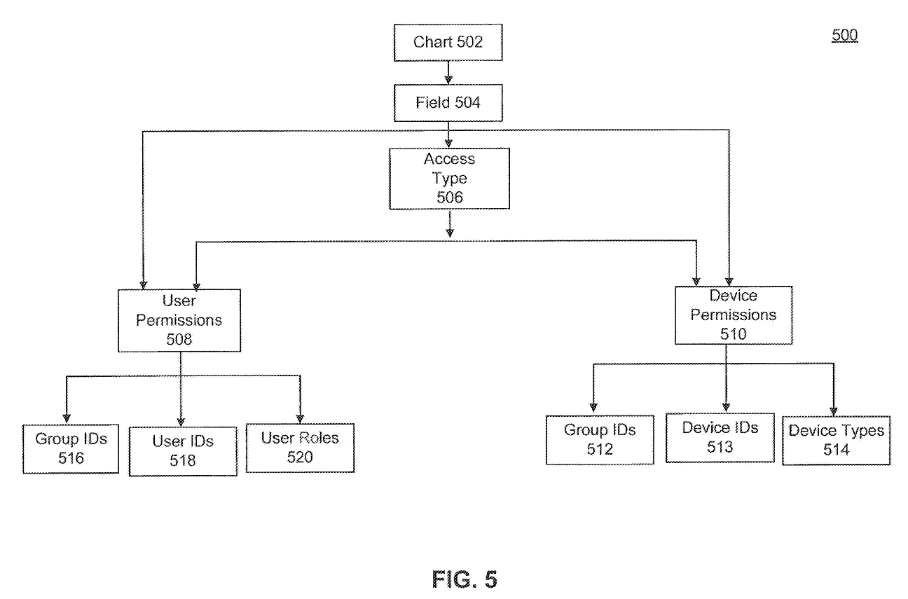

FIG. 5 displays types of authorization information that may be associated with each field 504 of chart 502 and stored in, for example, authorization information 224 of FIG. 2, according to an example embodiment. In an embodiment, chart 502 may be associated with access type 506, user permissions 508, or device permissions 510 directly. Therefore, both fine-grained authorization information on the field-level and course-grained authorization information, on the chart-level may be configured by, for example, chart configuration component 204 of FIG. 2.

As shown, in an embodiment, one field 504 may be directly associated with user permissions 508. User permissions 508 may include: one or more allowed group IDs 516 each of which may be associated with one or more user IDs, one or more allowed user IDs 518, or one or more allowed user roles 520. In am embodiment only a user satisfying at least one user permissions 508 setting may access field 504. Group IDs 516 may designate users that are in a medical facility, a group of facilities, a medical organization, or an insurance company. In an embodiment, group IDs 516 may further refer to medical practice groups, such as a radiology practice within a general hospital, or a cross-section of Individuals across one or more practices.

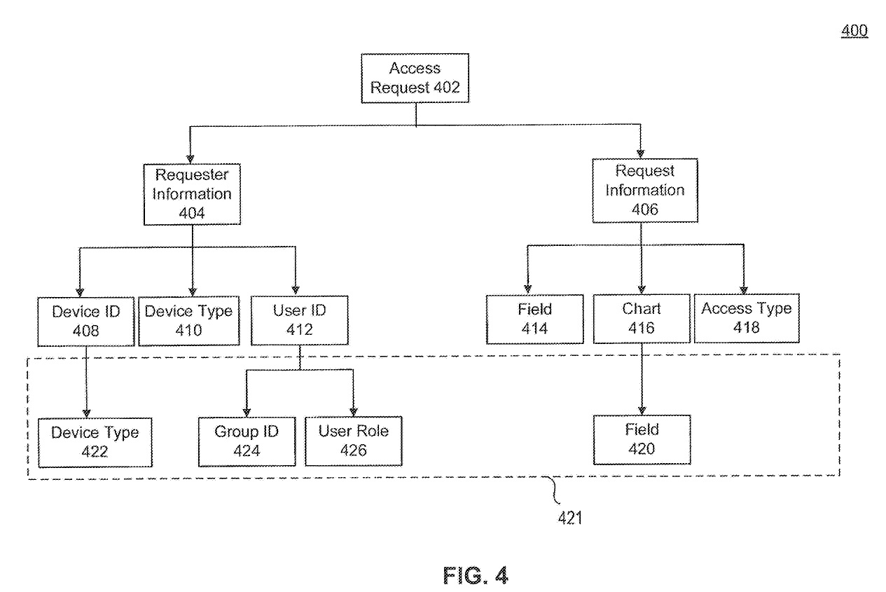

In an embodiment, user permissions 508 may include settings that enable one or more specific users the right to grant or revoke access of other users or devices to portions of medical chart 300. As depicted in FIG. 5, the one or more specific users may be designated by group IDs 516, user IDs 518, user roles 520, or a combination thereof. In an embodiment, portions of medical chart 300 may refer to field 414 or chart 416 as described with respect to FIG. 4.

For example, field 504 may be related to a patient's sensitive medical information. In this example, group IDs 516 may be empty or null, user IDs may include usernames or IDs of specific doctors and nurses at a medical practice, and user roles 520 may include only doctors or nurses. Other user roles such as receptionist, custodian, and security guard and user IDs corresponding to these other user roles may not be granted access to field 504.

In an embodiment, each of group IDs 516, user IDs 518, and user roles 520 may be further associated with, access-type permissions such as read-only, write-only, or read-write. For example, a nurse user role may have read-only permissions and a doctor user role may have read-write permissions. In an embodiment, group IDs 516, user IDs 518, or user roles 520 of a user may be received from charting application 108 of charting device 106. In an embodiment, a users group ID or user role(s) may be retrieved from charting database 218 based on a user 113 received from, for example, charting device 106A.

In an embodiment, field 504 may be directly associated, with device permissions 510. Device permissions 510 may include: one or more allowed group IDs 512 each including one or more device IDs, one or more allowed device IDs 513, or one or more device types 514. In an embodiment, only a device, satisfying at least one device permissions 510 setting may access field 504. For example, field 504 may be related to a patient's blood pressure measurement, an example biometric status, in this example, group IDs 512 may refer to a group of blood pressure monitors each assigned to the same group ID, device IDs 513 may be IP addresses or other unique identifiers of the blood pressure monitors, and device types 514 may be a blood pressure measuring device. Device types 514 may be reflective of characteristics of the device including a function of the device (e.g., measuring blood pressure) or a version or model of the device. Additionally, group IDs 512 may be assigned to a device by an administrator based on a location of the device (e.g., a device within a specific ward or exam room).

In an embodiment, each of group IDs 512, device IDs 513, and device types 514 may be further associated with access-type permissions such as read-only, write-only, or read-write. For the above blood pressure measuring example, each, of group IDs 512, device IDs 515, or device 514 may be associated with a write-only access type. In an embodiment, at least one of group IDs 512, device IDs 513, or device types of a device, requesting access to field 504 may be received from a requesting device. The requesting device may be any device from FIG. 1 including information-gathering devices 110, charting devices 106, or notification devices 122. In an embodiment, a device type or group ID may be retrieved from charting database 218 based on a device ID received from, for example, biosensor 112.

In an embodiment, field 504 may be associated with access type 506, such, as read-only, write-only, or read-write. Each of the possible access type 506 may be associated with one or more of user permissions 508 or device permissions 510 described above. Moreover, in an embodiment, any of access type 506, user permissions 508, or device permissions 510 may be dynamically assigned.

For example, charting interface 216 may receive a message from patient check-in device 114 indicating that a patient “John Smith” has arrived at a clinic. “Present: John Smith” may be written to field 504 stored as, for example, field 222A in charting database 218 of FIG. 2 and having device permissions 510 comprising device IDs 513 that includes an ID of patient check-in device 114. A scheduling component (not shown) of chatting server 202 may dynamically assign an open room. Room #100, to the patient “John Smith” and request chart configuration component 204 to assign, a group ID “Room #100” as one of group IDs 512 permitted to read from field 504. Then, display device 138 located, for example, above a door of Room #100 and having the group ID “Room #100” may receive and display the message “present: John Smith” from field 504.

In an embodiment, access type 506 may include access-type permissions indicating whether and how much field 504 may be shared, i.e., associated with read-only or read-write permissions. For example, data within field 504 may be designated by an administrator to be never shared (e.g., requested by patient), always shared (e.g., data includes vitals statuses), or restrictively shared (e.g., data includes psychiatrist analysis to be shared with patient and his primary physician only).

Returning to FIG. 2, authorization component 206 determines whether a request to access a medical chart, such as chart 220, or a field from the medical chart, such as field 222A, may be permitted based on authorization information 224 assigned to chart 220 or field 222A. respectively, the request to access the medical chart may be from information-gathering sensors 110, charting devices 106, or notification devices 122 of FIG. 1.

FIG. 4 displays types of information that may be received or retrieved based on the access request 402 from a requesting device, according to an example embodiment. Access request 402 may include requester information 404 and request information 406.

A requesting device may send requester information 404 including one or more of device ID 408, device type 410, or user ID 412 in its access request 402 to access a medical chart or one or more, fields of the medical chart. For example, a doctor may provide a username and a password to log in to charting application 108A or; charting, device 106A of FIG. 1. Therefore, when the requesting device, charting device 106A, requests access to a medical chart, the access request may include the doctor's username as user ID 412. But, if the requesting device is biosensor 112, no user ID 412 may be included in access request 402. Instead, requester information 404 in access request 402 may include device ID 408, i.e., an IP address of biosensor 112, that uniquely identities biosensor 112. Other device ID 408 identifying the specific device generating access request 402 may include a host ID of the device, a host name, or a combination thereof. The host ID may be a volume serial number, a MAC address, an IF address, or a combination thereof.

The requesting device may send request information 406 including one or more of field 414, chart 416, and access type 418. For example, a collaborator such as a doctor or a nurse may user charting device 106 to access a specific chart 416, e.g., a patient's medical chart. But, information-gathering devices 110 may, for example, only access one or more field 414, in either case, request information includes access type 418 that is requested. Access type 418 may include tread-only, write-only, or read-write. In an embodiment, retrieved fields 421 including, for example, device type 422, group ID 424, user role 426, or field 420 of corresponding received information may be further retrieved from charting database 218.

Returning to FIG. 2, authorization component 206 may first use received request information 406 from a requesting device to locate chart 220 or one or more field 222 of chart 220 in charting database 218. Based on received requester information 404 and any retrieved fields 421, authorization component 206 may look up authorization information 224, further explained in FIG. 4, of charting database 218 to determine whether to process request information 406 of the requesting device. Authorization component 206 may permit the requesting device access to a requested chart 200 or field 222 if the received requester information 404 matches user permission's 508 or device permissions 510 for a specific chart 502 or field 504 and access type 506 as specified in request information 406.

Concurrent charting component 208 tracks a plurality of devices used by users to engage in collaborative charting. Specifically, concurrent charting component 208 may track devices that are concurrently accessing each chart 220 of an EHR stored in charting database 218. A concurrent access may be having chart 220 opened, requesting to open chart 220, or requesting to edit one or more fields 222 of chart 220. Devices that concurrently access chart 220 may include charting devices 106, information-gathering devices 110, or notification devices 122. The plurality of tracked devices may be cached in active chart-device associations 210 on charting application server 202 or persisted in charting database 218. In an embodiment, concurrent charting component 208 may track a plurality of devices that are concurrently accessing one or more fields 222 of chart 200. The field-chart associations may be cached in charting application server 202 or persisted in charting database 218.

In an embodiment, active chart-device associations 210 may store a set or a list of devices concurrently accessing each chart 200. Chart-device associations 210 may store a sub-lists or separate lists (or sets) of devices concurrently accessing each field 222 of chart 200. For example, when charting device 106A requests access to chart 220 and is authorized by authorization component 206, concurrent charting component 208 may associate charting device 106A with chart 220 in active chart-device associations 210. The association may be made by adding charting device 106A to the set of devices concurrently accessing chart 220. When a user closes charting application 108A of charting device 106A, concurrent charting component 208 may disassociate charting device 106A with chart 220 by removing charting device 106A from the active set. Similarly, field 222B may be associated with charting device 106A and, for example, biosensor 112. Therefore, both charting device 106A and biosensor 112 may collaboratively and concurrently view or edit field 222B depending on assigned authorization information 224.

In an embodiment, concurrent charting component 208 may resolve and apply concurrent, authorized changes from a plurality of devices if changes modify fields within a chart independently. For example, a patient's chart 220 may include field 222A describing a body temperature status and field 222B describing a patient's chief complaint. While updating the patient's chief complaint based on input from charting device 106A accessing chart 220, concurrent charting component 208 may receive the patient body temperature from biosensor 112 associated with field 222A. Due to the fields being independently modified, concurrent charting component 208 may resolve the concurrent changes by applying both changes to fields 222A-B. Then, concurrent charting component 208 may concurrently persist the changes to charting database 218.

In an embodiment, concurrent charting component 208 may resolve and apply concurrent, authorized, changes from a plurality of devices to the same field within a chart. Concurrent charting component 208 may utilize, for example, operational transformation or differential synchronization to merge concurrent changes on the same field. Upon merging changes, concurrent charting component 208 may apply the merged changes and persist the changes to charting database 218.

Concurrent charting component 208 may further apply or merge concurrent changes from multiple devices based on priorities configured for each of the multiple devices with respect to the held or the chart that is being changed. In an embodiment, only specific authorized devices or users may directly edit a field, but concurrent changes from other users or devices may be applied as tracked changes or annotations.

Propagation component 212 sends concurrently applied changes to devices accessing chart 200 or fields 222 modified by the applied changes. In an embodiment, when concurrent charting component 208 resolves and applies concurrent changes to the chart or fields, propagation component 212 may find in active chart-device associations 210 a list for a modified chart or a list for the modified field. Then, propagation component 212 may send changes in real time to each of the devices currently accessing or are associated with the modified chart or field.

In an embodiment, propagation component 212 may send modified fields or indicate the fields have been modified to passive devices, such as notification devices 122, if certain criteria are met. For example, propagation component may send the modified field periodically, on-request, or when a value of the modified field associated with the passive devices exceeds a pre-determined threshold.

FIG. 3 illustrates an example chart illustrating various held, according to an example embodiment. Medical chart 300 of “Sarah Williams” may be retrieved from, charting database 218 and displayed within charting application 108A. As shown, medical chart 300 may include various fields including, profile fields 302, collaborators field 316, patient status fields 318, diagnosis fields 320, and messenger fields 322. As described with respect to FIG. 2, based on administrator selection, chart configuration component 204 may partition medical chart 300 into the fields shown. For ease of understanding, various fields will be described with respect to a patient encounter for a doctor's appointment.

For example, when a patient, “Sarah Williams,” arrives at a clinic, the patient may be requested m nil out basic information on patient check-in device 114 such as a tablet. In an embodiment concurrent charting component 208 may associate patient check-in device 114 with encounter fields 304 and chief complaint field 306 such that when a patient fills out the corresponding information using patient check-in device 114, concurrent charting component 208 may apply the updates to encounter fields 304 and chief complaint field 306. Propagation component 212 may then send or push updated fields to active devices accessing the fields and persist the modified fields to charting database 218.

During the scenario where the patient arrives at a clinic, a receptionist accessing “Sarah's” medical chart 300 using charting application 108A may see the patient's information populate encounter fields 304 and chief complaint field 306 in real time. Real-time updates may be possible because charting device 106A operating charting application 108A may be authorized to access and be associated with medical chart 300.

The receptionist may then, for example, request chart configuration component 204 to assign and authorize a group of devices (e.g., biosensor 112 within a certain examination room) to be associated with vitals sign 308. Therefore, when a nurse applies biosensor 112, such as a network-enabled thermometer, the temperature gathered by biosensor 112 may be transmitted to charting server 202. Concurrent charting component 208 applies the changes and propagation component 212 updates the temperature field to 98.8 degrees Fahrenheit.

After Sarah's appointment with her doctor “E. Smith,” Dr. Smith may further operate a transcription device, an example information-gathering device 110, to transcribe his diagnosis. Based on authorization information 224, concurrent charting component 208 may apply the transcribed diagnosis to notes field 310 from diagnosis fields 320. Additionally, authorization component 206 may enable Dr. Smith to engage other medical personnel from within or across practices to engage in a collaboration session to diagnosis Sarah's conditions. For example, Dr. Smith may send a link or a username/password combination to a specialist physician, “A. Adams” to enable Dr. Adams to also concurrently view and edit medical record 300. As shown, messenger fields 322 displays comments or annotations 314A and 314B made by Dr. Adams and Dr. Smith, respectively.

In an embodiment, collaborators field 316 may display the collaborators including medical personnel or users that are currently accessing medical chart 300. Concurrent charting component 208 may track the users displayed in collaborators field 316 or devices operated by the users within active chart-device associations, if any field is updated by an authorized collaborator, propagation component 212 may send the updated, field to each active user of collaborators field 316.

### Method

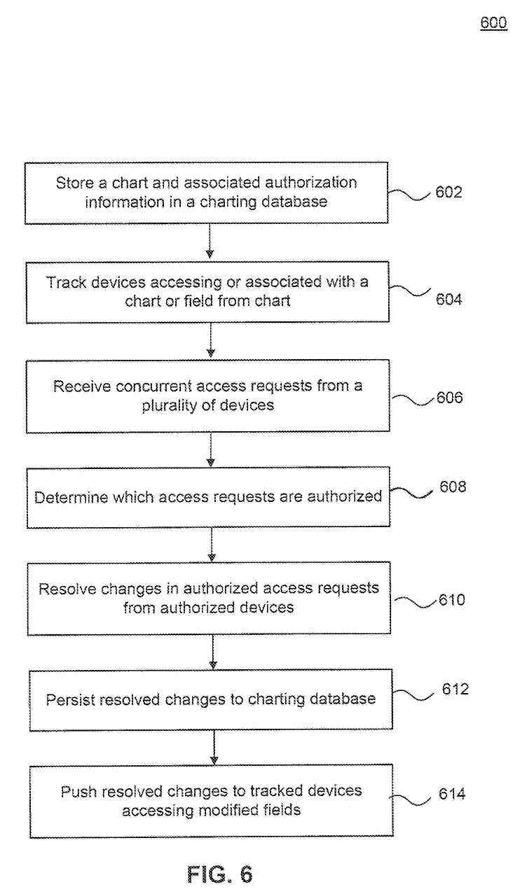

FIG. 6 is a flowchart illustrating an example method 600 for providing collaborative charting with device integration, according to an example embodiment. Method 600 may be performed by processing logic that can comprise hardware (e.g., circuitry, dedicated logic, programmable logic, microcode, etc.), software (e.g., instructions run on a processing device), or a combination thereof. The following steps of method 600 may be performed by a chatting management system, such as charting management system 200 of FIG. 2, in an embodiment, the steps of method 600 need not be performed in the order shown.

In step 602, charting database 218 stores a chart partitioned into a plurality of fields. Each field may describe medical Information of a patient associated with the chart. Charting database 218 further stores, for each field of the plurality of fields, authorization information 224 indicating which devices or users are permitted to access or alter each field. In an embodiment, an administrator, such as the patient himself, may configure authorization information 324.

In step 604, concurrent charting component 208 tracks a plurality of devices that are actively accessing or are associated with a chart or a field from the chart. For example, charting device 106A from FIG. 1 may be actively accessing the chart if the chart is opened and being viewed within chatting application 108A. In an embodiment, concurrent charting component 208 may separately track devices that are associated with one or more specific fields of the chart. These devices may include, for example, notification devices 122 from FIG. 1 that are not necessarily directly accessing the fields or chart, but are instead associated with or assigned to a field or chart. Notification devices 122 may additionally be configured to output a status or indication of the associated field. Devices accessing a specific field may include information-gathering devices 110 of FIG. 1 that populates the field of the chart, such as a vitals sign field.

In step 606, charting interface 216 receives concurrent access requests from a plurality of devices. Concurrent access requests may include read access or changes, which are write accesses. For example, charting interface 216 may receive from at least two devices of the tracked devices, changes concurrently made to at least one field of the plurality of fields. The plurality of requests may include changes to one or more fields of the chart from multiple medical personnel as well as measurements gathered by information-gathering devices 110.

In step 608, authorization component 206 determines which of the concurrent access requests from step 606 are authorized. The determination may be based on whether authorization component 206 matches requester information and request information within an access request with authorization information 224 assigned to the field or chart being requested. As part of step 608, authorization component 206 may also determine whether requesting devices of step 606 are authorized. In an embodiment, concurrent charting component 208 may request the authorization component 206, which may be incorporated within concurrent charting component 208, to perform the determining.

In step 610, concurrent charting, component 208 resolves changes of access requests authorized in step 608. As described with respect to FIG. 2, concurrent charting component 208 may apply changes if concurrent changes independently modify fields within the chart. Otherwise, concurrent charting component 208 may merge changes made to a single field based on priorities of the access requests and associated devices or users.

In step 612, propagation component 212 persists the resolved changes of step 608 to charting database 218.

In step 614, propagation component 212 transmits or pushes resolved changes of step 610 to tracked devices of step 604 that are determined to be accessing or are associated with fields that have been changed. In an embodiment, steps 612 and step 614 may be performed concurrently. In an embodiment, propagation component 212 may only transmit resolved changes that have been successfully persisted in step 612.

### Example Computer System

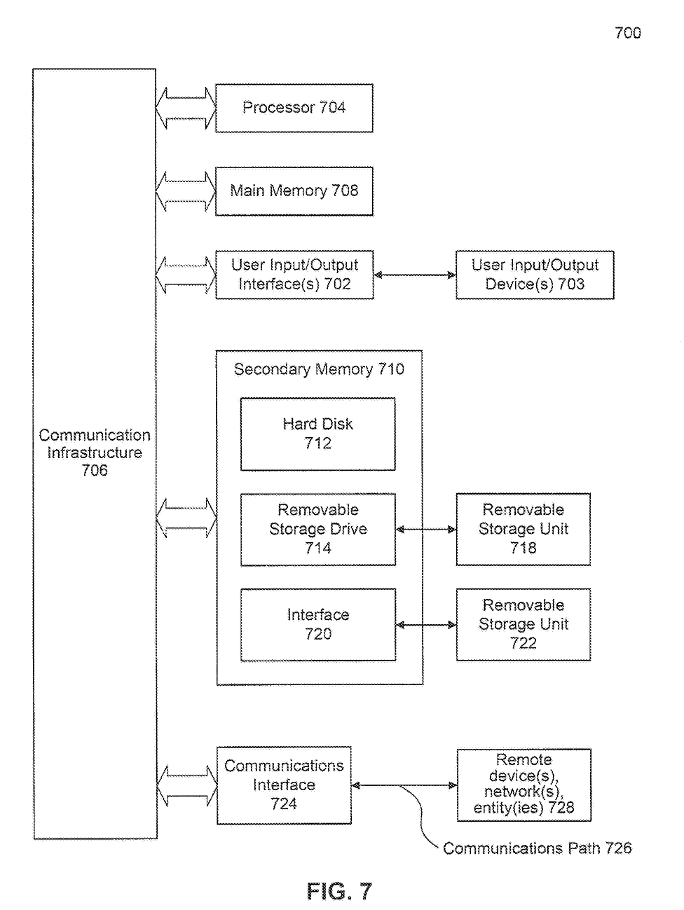

Various embodiments can be implemented, for example, using one or more well-known computer systems, such as computer system 700 shown in FIG. 7. Computer system 700 can be any well-known computer capable of performing the functions described herein.

Computer system 700 includes one or more processors (also called central processing units, or CPUs), such as a processor 704. Processor 704 is connected to a communication infrastructure or bus 706.

One or more processors 704 may each be a graphics processing unit (GPU), in an embodiment, a GPU is a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 also includes user input/output device(s) 703, such as monitors, keyboards, pointing devices, etc., that, communicate with communication infrastructure 706 through user input/output interface(s) 702.

Computer system 700 also includes a main or primary memory 708, such as random access memory (RAM). Main memory 708 may include one or more levels of cache. Main memory 708 has stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 includes a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 reads from and/or writes to removable storage unit 718 in a well-known manner.

According to an exemplary embodiment, secondary memory 710 may include other means, instrumentalities or other approaches for allowing computer programs and/or other instructions and/or data to be accessed by computer system 700. Such means, instrumentalities or other approaches may include, for example, a removable storage unit 722 and an interface 720. Examples of the removable storage unit 722 and the interlace 720 may include a program cartridge and cartridge interface (such as that found in video game devices), a removable memory chip (such as an EPROM or PROM) arid associated socket, a memory stick and USB port, a memory card and associated memory card slot, and/or any other removable storage unit and associated interface.

Computer system 700 may further include a communication or network interface 724. Communication interlace 724 enables computer system 700 to communicate and interact with any combination of remote devices, remote networks, remote entities, etc. (individually and collectively referenced by reference number 728). For example, communication interlace 724 may allow computer system 700 to communicate with remote devices 728 over communications path 726, which, may be wired and/or wireless, and which may include any combination of LANs, WANs, the internet, etc. Control logic and/or data may be transmitted to and from computer system 700 via communication path 726.

In an embodiment a tangible apparatus or article of manufacture comprising a tangible computer useable or readable medium having control logic (software) stored thereon is also referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), causes such data processing devices to operate as described herein.

Based on the teachings contained in this disclosure, it will be apparent to persons skilled in the relevant art(s) how to make and use embodiments of the invention using data processing devices, computer systems and/or computer architectures other than that shown in FIG. 7, in particular embodiments may operate with software, hardware, and/or operating system implementations other than those described herein.

### Conclusion

It is to be appreciated that the Detailed Description section, and not the Summary and Abstract sections (if any), is intended to be used to interpret the claims. The Summary and Abstract sections (if any) may set forth one or more but not all exemplary embodiments of the invention as contemplated by the inventor(s), and thus, are not intended to limit the invention or the appended claims in any way.

While the invention has been described herein with reference to exemplary embodiments for exemplary fields and applications, it should be understood that the invention is not limited thereto. Other embodiments and modifications thereto are possible, and are within the scope and spirit of the invention. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

The breadth and scope of the invention should not be limited by any of the above-described exemplary embodiments, but should be defined only in accordance with the following claims and their equivalents.

What is claimed is:

1. A system for collaborative charting with device integration, comprising:
a computing device;
a charting database that includes (i) a chart partitioned into a plurality of fields describing medical information of a patient associated with the chart and (ii) for each field of the plurality of fields, authorization information describing who is permitted to alter the field;
a charting interface, implemented on the computing device, that receives, from at least two devices of a plurality of devices, changes concurrently made to at least one of the plurality of fields;
a concurrent charting component, implemented on the computing device, that:
tracks the plurality of devices to determine which are accessing or altering, the at least one changed field,
determines, based on the authorization information, which of the received concurrent changes are authorized, and
resolves the concurrent changes from the at least two devices; and
a propagation component, implemented on the computing device, that sends the resolved concurrent changes to devices, from the tracked plurality of devices, determined to be accessing or altering the changed field.

2. The system of claim 1, further comprising:
a chart configuration component, implemented on the computing device, that:
selects, based on an input from an administrator, the plurality of fields to partition the chart, and
configures the authorization information for each field of the plurality of fields.

3. The system of claim 1, further comprising:
an authorization component, implemented on the computing device, that determines whether a first change from a first device of the at least two devices is authorized based on a type of the first device, a user operating the first device, the field requested by the first device, or a type of requested access.

4. The system of claim 1, wherein the concurrent changes include a first change from a first device and a second change, from a second device, the second change modifying a second field from the plurality of fields, and wherein the concurrent charting component further:
determines that the first change modifies one or more fields independently of the second field; and
requests the propagation component to send the chart containing the first and second changes to both the first device and the second device.

5. The system of claim 1, wherein the concurrent charting component further:
determines that the concurrent changes modify the same field from the plurality of fields; and merges the concurrent changes based on priorities of each of the at least two devices making the concurrent changes.

6. The system of claim 1, wherein the charting interlace receives a request from a charting device to access the chart of the patient, wherein an authorization component determines whether the charting devices is authorized to access the chart, and wherein upon authorizing the charting device, the concurrent charting component adds the charting device to the tracked plurality of devices that are determined to he accessing one or more fields from the plurality of fields of the chart.

7. The system of claim 1, wherein the plurality of devices includes a device that outputs a status of the one or more fields, and wherein the propagation component determines that a value of the resolved concurrent changes exceeds a pre-determined threshold before sending the resolved concurrent changes to the device.

8. A method for collaborative charting with device integration, comprising:
storing, within a charting database by at least one processor, (i) a chart partitioned into a plurality of fields describing medical information of a patient associated with the chant and (ii) for each field of the plurality of fields, authorization information describing who is permitted to alter the field;
receiving, by the at least one processor, from at least two devices of a plurality of devices, changes concurrently made to at least one of the plurality of fields;
tracking, by the at least one processor, the plurality of devices to determine which are accessing or altering the at least one changed field,
determining, by the at least one processor, based on the authorization information, which of the received concurrent changes are authorized;
resolving, by the at least one processor, the concurrent changes from the at least two devices; and
sending, by the at least one processor, the resolved concurrent change to devices, from the tracked plurality of devices, determined to be accessing or altering the changed field.

9. The method for claim 8, further comprising:
selecting, based on an input from an administrator, the plurality of fields to partition the chart; and
configuring the authorization information for each field of the plurality of fields.

10. The method of claim 8, further comprising:
determining whether a first change from a first, device of the at least two devices is authorized based on a type of the first, device, a user operating the first device, the field requested by the first device, and a type of requested access.

11. The method of claim 8, wherein the concurrent changes include a first change from a first device and a second change from a second device, the second change modifying a second field from the plurality of fields, and wherein the method further comprises:
determining that the first change modifies one or more fields independently of the second field; and
requesting the propagation component to send the chart containing the first and second changes to both the first device and the second device.

12. The method of claim 8, further comprising:
determining that the concurrent changes modify the same field from the plurality of fields; and
merging the concurrent changes based on priorities of each of the at least two devices making the concurrent changes.

13. The method of claim further comprising;
receiving a request from a charting device to access the chart of the patient; authorizing the charting device; and
upon authorizing the charting device, adding the charting device to the tracked plurality of devices that are determined to he accessing one or more fields from the plurality of fields of the chart.

14. The method of claim 8, wherein the plurality of devices includes a device that outputs a status of the one or more fields, the sending further comprising;
determining that a value of the resolved changes exceeds a pre-determined threshold before sending the resolved concurrent changes to the device.

15. A program storage device tangibly embodying a program of instructions executable by at least a computing, device to perform a method for collaborative charting with device integration, comprising:
storing, within a charting database, (i) a chart partitioned into a plurality of fields describing medical information of a patient associated with the chart and (ii) for each field of the plurality of fields, authorization information describing who is permitted to alter the field;
receiving from at least two devices of a plurality of devices, changes concurrently made to at least one of the plurality of fields;
tracking the plurality of devices to determine which are accessing or altering the at least one changed field,
determining based on the authorization information, which of the received concurrent changes are authorized:
resolving the concurrent changes from the at least two devices; and
sending the resolved concurrent change to devices, from the tracked plurality of devices, determined to be accessing or altering the changed field.

16. The program storage device of claim 15, wherein the method further comprises;
selecting, based on an input from an administrator, the plurality of fields to partition the chart; and
configuring the authorization information for each field of the plurality of fields.

17. The program storage device of claim 15, wherein the determining comprises:
determining whether a first change from a first device of the at least two devices is authorized based on a type of the first device, a user operating the first device, the field requested by the first device, and a type of requested access.

18. The program storage device of claim 15, wherein the concurrent changes include a first change from a first device and a second change from a second device, the second change modifying a second field from the plurality of fields, and wherein the method further comprises:
determining that the first change modifies one or more fields independently of the second field; and
requesting the propagation component to send the chart containing the first and second changes to both the first device and the second device.

19. The program storage device of claim 15, wherein the resolving comprises:
determining that the concurrent changes modify the same field from the plurality of fields; and
merging the concurrent changes based on priorities of each of the at least two devices making the concurrent changes.

20. The program storage device of claim 15, wherein tracking comprises:
receiving a request from a charting device to access the chart of the patient;
authorizing the charting device; and
upon authorizing the chatting device, adding the charting device to the tracked plurality of devices that are determined to be accessing one or more fields from the plurality of fields of the chart.

21. The program storage device of claim 15, wherein the plurality of devices includes a device that outputs a status of the one or more fields, the sending further comprising:
determining that a value of the resolved changes exceeds a pre-determined threshold before sending the resolved concurrent changes to the device.
